(19) United States
(12) Patent Application Publication
(10) Pub. No.: US 2013/0284372 A1
(43) Pub. Date: Oct. 31, 2013

(54) ESC COOLING BASE FOR LARGE DIAMETER SUBSRATES

(71) Applicants: Hamid TAVASSOLI, Cupertino, CA (US); Kallol BERA, San Jose, CA (US); Douglas BUCHBERGER, Livermore, CA (US); James C. CARDUCCI, Sunnyvale, CA (US); Shahid RAUF, Pleasanton, CA (US); Ken COLLINS, San Jose, CA (US)

(72) Inventors: Hamid TAVASSOLI, Cupertino, CA (US); Kallol BERA, San Jose, CA (US); Douglas BUCHBERGER, Livermore, CA (US); James C. CARDUCCI, Sunnyvale, CA (US); Shahid RAUF, Pleasanton, CA (US); Ken COLLINS, San Jose, CA (US)

(21) Appl. No.: 13/860,475

(22) Filed: Apr. 10, 2013

Related U.S. Application Data
(60) Provisional application No. 61/638,375, filed on Apr. 25, 2012.

(51) Int. Cl. B01J 15/00; B23K 15/00; B23C 3/13

(52) U.S. Cl. CPC B01J 15/00; B23C 3/13; B23K 15/0006
USPC 156/345.29; 409/131; 219/121.14

(57) ABSTRACT

Embodiments include a base for an electrostatic chuck (ESC) assembly for supporting a workpiece during a manufacturing operation in a processing chamber, such as a plasma etch, clean, deposition system, or the like. Inner and outer fluid conduits are disposed in the base to conduct a heat transfer fluid. In embodiments, a counter-flow conduit configuration provides improved temperature uniformity. The conduit segments in each zone are interlaced so that fluid flows are in opposite directions in radially adjacent segments. In embodiments, each separate fluid conduit formed in the base comprises a channel formed in the base with a cap e-beam welded to a recessed lip of the channel to make a sealed conduit. To further improve the thermal uniformity, a compact, tri-fold channel segment is employed in each of the outer fluid loops. In further embodiments, the base includes a multi-contact fitting RF and DC connection, and thermal breaks.

### CROSS REFERENCE TO RELATED APPLICATIONS

This application claims the benefit of U.S. Provisional Application No. 61/638,375 filed on Apr. 25, 2012, titled “ESC COOLING BASE FOR LARGE DIAMETER SUBSTRATES,” the entire contents of which are hereby incorporated by reference in its entirety for all purposes.

### TECHNICAL FIELD

Embodiments of the present invention relate to the microelectronics manufacturing industry and more particularly to temperature controlled chucks for supporting a workpiece during plasma processing.

### BACKGROUND

Power density in plasma processing equipment, such as those designed to perform plasma etching of microelectronic devices and the like, is increasing with the advancement in fabrication techniques. For example, powers of 5 to 10 kilowatts are now in use for 300 mm substrates. With the increased power densities, enhanced cooling of a chuck is beneficial during processing to control the temperature of a workpiece uniformly. Control over workpiece temperature and temperature uniformity is made more difficult where rapid temperature setpoint changes are desired, necessitating a chuck be designed with smaller thermal time constants.

The industry is now progressing toward 450 mm diameter substrates. Surface area of a chuck to support these larger substrates is approximately 2.25 times that of the current state of the art of 300 mm substrates. These larger chucks would have significantly greater mass if conventional construction techniques are applied to merely scale up the chuck. For example, one 300 mm design weighing in at around 14-15 lbs. increases to over 30 lbs. when simply scaled up to accommodate 450 mm diameter workpieces. This greater mass detrimentally increases thermal time constants of the system heating/cooling the workpiece.

Uniform application of heating/cooling power to a chuck is further hindered by the need to deliver both higher RF power and DC voltages to electrostatically clamp a workpiece to the chuck. Both RF power and DC voltage are also to be delivered in a uniform manner, making their individual routing within a chuck competitive with that of heat/cooling power delivery.

A chuck assembly and chuck assembly fabrication techniques that achieve sufficient rigidity and temperature stability for support of 450 mm workpieces, minimize thermal mass, and provide good thermal uniformity across the surface area of the workpiece are advantageous.

### SUMMARY

Embodiments include a base for an electrostatic chuck (ESC) assembly for supporting a workpiece during a manufacturing operation in a processing chamber, such as a plasma etch, clean, deposition system, or the like, which utilizes the chuck assembly. In embodiments, a chuck assembly includes a dielectric layer with a top surface to support the workpiece. In embodiments, the dielectric layer includes an aluminum nitride (AlN) puck bonded to an aluminum base. Inner fluid conduits are disposed in the base, below the dielectric layer, beneath an inner areal portion of the top surface. Outer fluid conduits are disposed in the base beneath an outer areal portion of the top surface. Each of the inner and outer fluid conduits may include two, three, or more fluid conduits arranged with azimuthal symmetry about a central axis of the chuck assembly. The fluid conduits are to conduct a heat transfer fluid, such as ethylene glycol/water, or the like, to heat/cool the top surface of the chuck and workpiece disposed thereon. In embodiments, an outlet of an inner fluid conduit is positioned at a radial distance of the chuck that is between an inlet of the inner fluid conduit and an inlet of an outer fluid conduit. The proximity of the two inlets to the outlet improves temperature uniformity of the top surface.

In embodiments, a counter flow conduit configuration provides improved temperature uniformity. The cooling conduit segments in each zone are interlaced so that fluid flows are in the opposite direction in radially adjacent segments.

In an embodiment, each separate fluid conduit formed in the base comprises a channel formed in the base with a cap e-beam welded to a recessed lip of the channel to make a sealed conduit. The mass of the individual channel caps is minimal and obviates the need to have a sub-base plate of the same surface area as the chuck for a conduit sealing surface. The elimination of the sub-base plate reduces the mass of the chuck assembly by nearly 30% over prior designs. This reduced mass translates into faster transient thermal response compared to prior designs.

In an embodiment, outer fluid conduits include an overlap region where a section of a first outer fluid conduit overlaps a section of a second, adjacent, outer fluid conduit along an azimuthal angle or distance. In one such embodiment, an outlet of the first outer fluid conduit overlaps an inlet of the second fluid conduit. The overlap region reduces local hot spots relative to a design without such overlap. In an embodiment, an outer fluid conduit is routed to fold back on itself to make at least two passes over a given azimuthal angle. To further improve the thermal uniformity, a compact, tri-fold channel segment is employed in each of the outer fluid loops, with the inlet and outlet of adjacent loops overlapping.

In embodiments, a chuck assembly includes a thermal break disposed within the cooling channel base between the inner and outer fluid conduits to improve the independence of temperature control between the inner and outer portions of the top surface. Depending on the embodiment, the thermal break includes a void or a second material with a higher thermal resistance value than that of the base material. In certain embodiments, the thermal break forms an interrupted annulus encircling an inner portion of the top surface with interruptions at points where a full thickness of the cooling channel base is provided for greater mechanical rigidity of the base.

In further embodiments, where an RF and DC electrode is to be inserted into the base, the base include a multi-contact fitting forming an outer circumference of the base coupler to couple to an RF connector, and a copper fitting forming an inter circumference of the base coupler to couple to a DC connector, with a insulator, such as Teflon disposed between separate electrical contacts of the base coupler.

### BRIEF DESCRIPTION OF THE DRAWINGS

Embodiments of the present invention are illustrated by way of example, and not limitation, in the figures of the accompanying drawings in which:

FIG. 1 is a schematic of a plasma etch system including a chuck assembly in accordance with an embodiment of the present invention;

FIG. 2 illustrates a plan view of a chuck assembly including a plurality of inner fluid conduits and a plurality of outer fluid conduits, in accordance with an embodiment of the present invention;

FIG. 3 illustrates a plan view of a chuck assembly including fluid conduit caps joined to the inner and outer fluid conduits, in accordance with an embodiment of the present invention;

FIG. 4 illustrates a cross-sectional view of a chuck assembly, in accordance with an embodiment of the present invention;

FIG. 5 illustrates a plan view of a chuck assembly with an alternate routing of the inner cooling loops where the inlets and outlets are disposed around a center of the chuck, in accordance with an embodiment of the present invention;

FIG. 6 illustrates an expanded cross-sectional view of a RF and DC power coupling incorporated into the chuck assembly, in accordance with an embodiment; and

FIG. 7 illustrates a method of fabricating a chuck assembly, in accordance with an embodiment of the present invention.

### DETAILED DESCRIPTION

In the following description, numerous details are set forth. It will be apparent, however, to one skilled in the art, that the present invention may be practiced without these specific details. In some instances, well-known methods and devices are shown in block diagram form, rather than in detail, to avoid obscuring the present invention. Reference throughout this specification to “an embodiment” means that a particular feature, structure, function, or characteristic described in connection with the embodiment is included in at least one embodiment of the invention. Thus, the appearances of the phrase “in an embodiment” in various places throughout this specification are not necessarily referring to the same embodiment of the invention. Furthermore, the particular features, structures, functions, or characteristics may be combined in any suitable manner in one or more embodiments. For example, a first embodiment may be combined with a second embodiment anywhere the two embodiments are not mutually exclusive.

As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. It should be understood that these terms are not intended as synonyms for each other. Rather, in particular embodiments, “connected” may be used to indicate that two or more elements are in direct physical, optical, or electrical contact with each other. “Coupled” my be used to indicated that two or more elements are in either direct or indirect (with other intervening elements between them) physical, optical, or electrical contact with each other, and/or that the two or more elements co-operate or interact with each other (e.g., as in a cause an effect relationship).

The terms “over,” “under,” “between,” and “on” as used herein refer to a relative position of one component or material layer with respect to other components or layers where such physical relationships are noteworthy. For example in the context of material layers, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similar distinctions are to be made in the context of component assemblies.

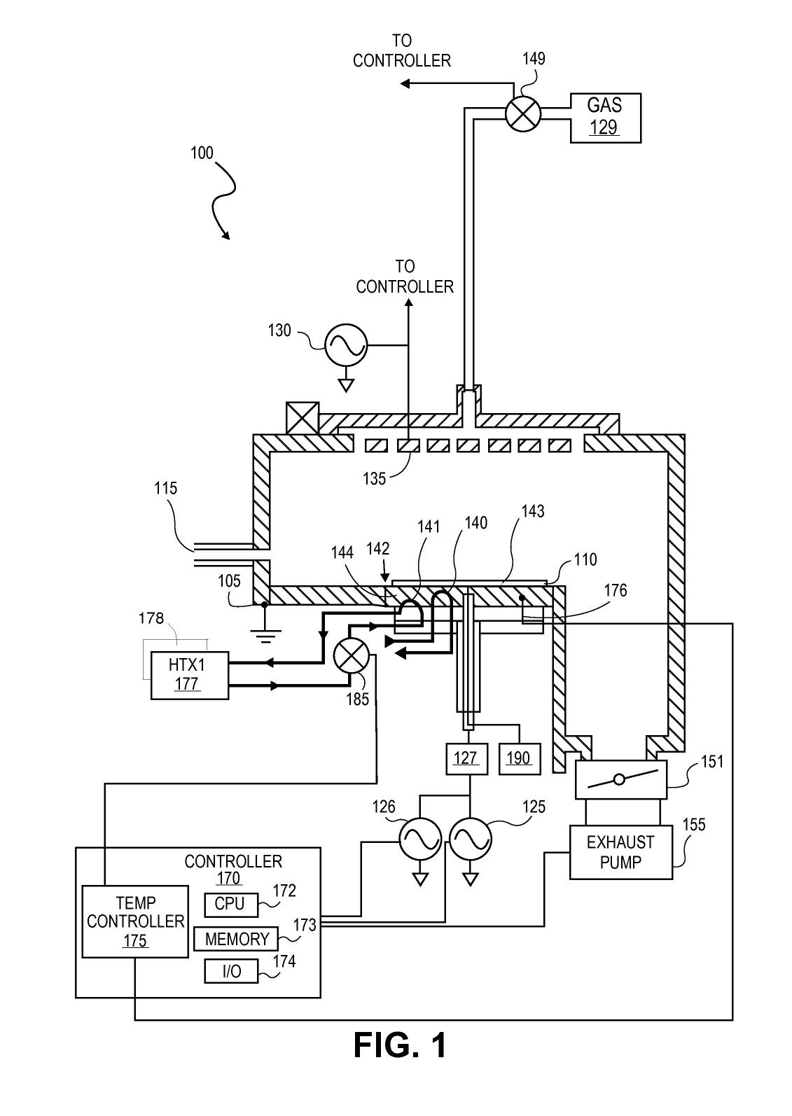

FIG. 1 is a schematic of a plasma etch system 100 including a chuck assembly 142 in accordance with an embodiment of the present invention. The plasma etch system 100 may be any type of high performance etch chamber known in the art, such as, but not limited to, Enabler™, MxP®, MxP+™, Super-E™, DPS II AdvantEdge™ G3, or E-MAX® chambers manufactured by Applied Materials of CA, USA. Other commercially available etch chambers may similarly utilize the chuck assemblies described herein. While the exemplary embodiments are described in the context of the plasma etch system 100, the chuck assembly described herein is also adaptable to other processing systems used to perform any substrate fabrication process (e.g., plasma deposition systems, etc.) which place a heat load on the chuck.

Referring to FIG. 1, the plasma etch system 100 includes a grounded chamber 105. A workpiece 110 is loaded through an opening 115 and clamped to a chuck assembly 142. The workpiece 110 may be any conventionally employed in the plasma processing art and the present invention is not limited in this respect. The workpiece 110 is disposed on a top surface of a dielectric layer 143 disposed over a cooling channel base 144. In particular embodiments, chuck assembly 142 includes a plurality of zones, each zone independently controllable to a setpoint temperature. In the exemplary embodiment, an inner thermal zone is proximate to the center of the workpiece 110 and an outer thermal zone is proximate to the periphery/edge of the workpiece 110. Process gases are supplied from gas source(s) 129 through a mass flow controller 149 to the interior of the chamber 105. Chamber 105 is evacuated via an exhaust valve 151 connected to a high capacity vacuum pump stack 155.

When plasma power is applied to the chamber 105, a plasma is formed in a processing region over workpiece 110. A plasma bias power 125 is coupled into the chuck assembly 142 to energize the plasma. The plasma bias power 125 typically has a low frequency between about 2 MHz to 60 MHz, and may be for example in the 13.56 MHz band. In the exemplary embodiment, the plasma etch system 100 includes a second plasma bias power 126 operating at about the 2 MHz band which is connected to the same RF match 127 as plasma bias power 125 and coupled to a lower electrode 120 via a power conduit 127. A plasma source power 130 is coupled through a match (not depicted) to a plasma generating element 135 to provide high frequency source power to inductively or capacitively energize the plasma. The plasma source power 130 may have a higher frequency than the plasma bias power 125, such as between 100 and 180 MHz, and may for example be in the 162 MHz band.

The temperature controller 175 is to execute temperature control algorithms and may be either software or hardware or a combination of both software and hardware. The temperature controller 175 may further comprise a component or module of the system controller 170 responsible for management of the system 100 through a central processing unit 172, memory 173 and input/output interfaces 174. The temperature controller 175 is to output control signals affecting the rate of heat transfer between the chuck assembly 142 and a heat source and/or heat sink external to the plasma chamber 105. In the exemplary embodiment, the temperature controller 175 is coupled to a first heat exchanger (HTX)/chiller 177 and a second heat exchanger/chiller 178 such that the temperature controller 175 may acquire the temperature setpoint of the heat exchangers 177, 178 and temperature 176 of the chuck assembly, and control heat transfer fluid flow rate through fluid conduits in the chuck assembly 142. The heat exchanger 177 is to cool an outer portion of the chuck assembly 142 via a plurality of outer fluid conduits 141 and the heat exchanger 178 is to cool an inner portion of the chuck assembly 142 via a plurality of inner fluid conduits 140. One or more valves 185, 186 (or other flow control devices) between the heat exchanger/chiller and fluid conduits in the chuck assembly may be controlled by temperature controller 175 to independently control a rate of flow of the heat transfer fluid to each of the plurality of inner and outer fluid conduits 140, 141. In the exemplary embodiment therefore, two heat transfer fluid loops are employed. Any heat transfer fluid known in the art may be used. The heat transfer fluid may comprise any fluid suitable to provide adequate transfer of heat to or from the substrate. For example, the heat transfer fluid may be a gas, such as helium (He), oxygen (O₂), or the like, or a liquid, such as, but not limited to ethylene glycol/water.

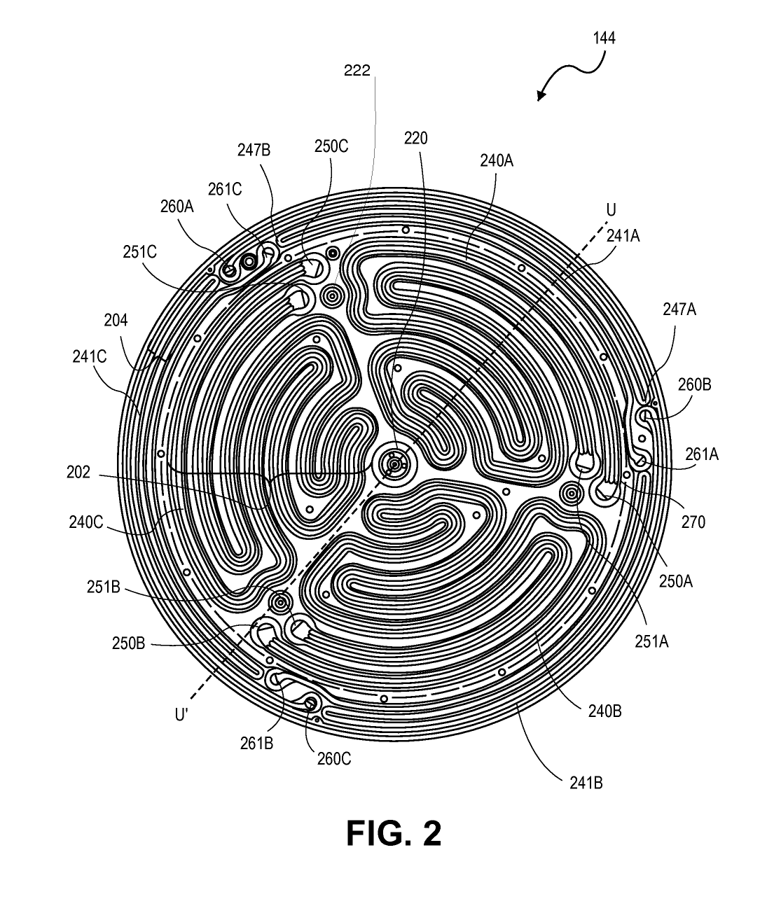

FIG. 2 illustrates a plan view of the cooling channel base 144. An underside of the cooling channel base 144 is shown with a top side over which a work piece is to be disposed removed (or transparent). As shown, a plurality of inner fluid channels 240 and a plurality of outer fluid channels 241 are recessed or embedded in the cooling channel base 144 and are dimensioned to pass a heat transfer fluid at a desired flow rate for pressures typical in the art (e.g., 3 PSI). The fluid channels 240, 241 may be routed around objects in the base, such as lift pin through holes 222 and a central axis 220 dimensioned to receive a conductor 190 to provide DC voltage a ESC clamp electrode disposed in the dielectric layer 143 (FIG. 1). In some embodiments, each of the inner fluid channels 240 have substantially equal fluid conductance and/or residence time to provide equivalent heat transfer fluid flow rates. In further embodiments, each of the outer fluid channels 241 have substantially equal fluid conductance and/or residence time to provide equivalent heat transfer fluid flow rates. Fluid conductance may be either the same or different between the inner and outer fluid channels 240 and 241. By utilizing a plurality of fluid channels 240, 241, the length of each fluid channel may be shortened, which may advantageously allow for a decreased change in temperature of the heat transfer fluid along the channel. Total flow rate of heat transfer fluid throughout the substrate support may be increased for a given pressure, further facilitating a decreased temperature range of the substrate support during use.

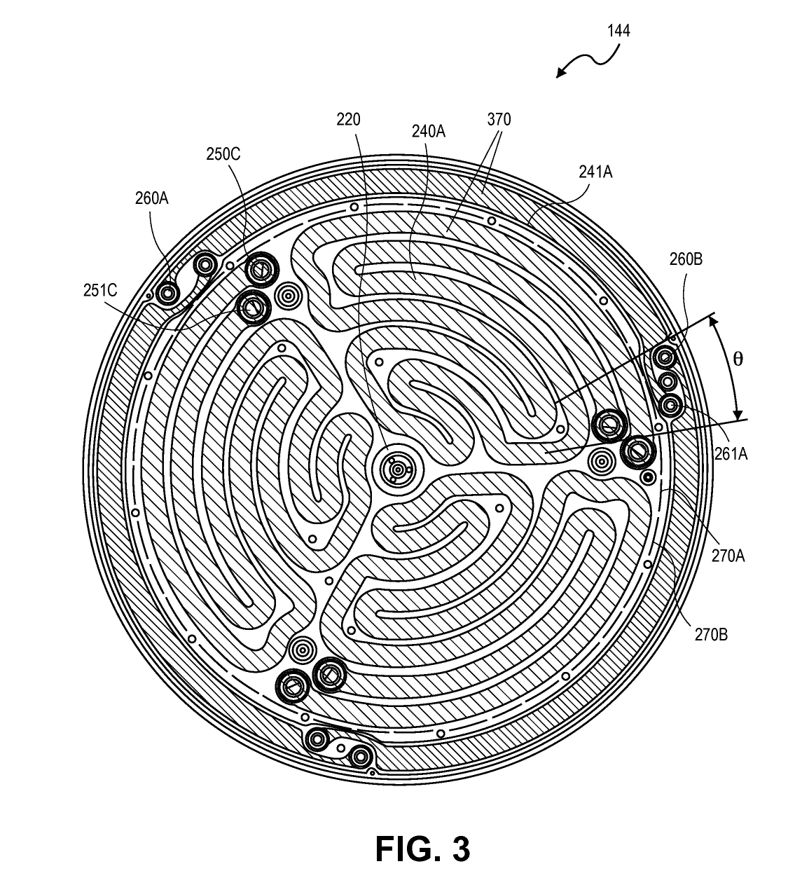

In an embodiment, the plurality of inner fluid channels 240 are disposed below an inner zone or portion 202 of the top surface extending outward from a central axis 220 to a first radial distance. The plurality of outer fluid channels 241 are disposed below an outer zone or portion 204, the outer portion 204 forming an outer annulus centered about the central axis 220 and extending outward from a second radial distance to an outer edge of the chuck assembly 242. Each of the inner portion 202 and outer portion 204 may comprise any number of fluid channels and may be arranged in any manner suitable to facilitate temperature uniformity across a top surface of the chuck assembly 142 (FIG. 1). For example, as depicted in FIG. 2, the inner portion 202 includes three inner fluid channels 240A, 240B, and 240C having substantially (i.e., effectively) equal lengths between inlets 250A, 250B, 250C and outlets 251A, 251B, 251C, respectively. In further embodiments the plurality of inner fluid channels 240 are positioned symmetrically about the central axis 220. For example, as illustrated in FIG. 2, the three inner fluid channels 240A, 240B and 240C are symmetrical azimuthally with each inner fluid channel spanning an azimuth angle φ of approximately 120°. The outer fluid channels have substantially equal lengths between inlets 260A, 260B, 260C and outlets 261A, 261B, 261C, respectively. As further depicted in FIG. 2, the outer portion 204 includes three outer fluid channels 241A, 241B, and 241C, also azimuthally symmetric, spanning approximately the same azimuth angle as each inner fluid channel 240, but having an azimuthal offset (e.g., counter-clockwise) relative to the inner fluid channel 240 where an outlet of one outer fluid channel (e.g., 261A) azimuthally overlaps an inlet of an adjacent outer fluid channel (e.g., 260B). This overlap is further illustrated in FIG. 3 as overlap 0 and has been found to improve thermal uniformity of the chuck assembly by eliminating a hot spot present if the inlet of one outer fluid channel is merely abutted to an outlet (or inlet) of an adjacent outer fluid channel with no overlap between adjacent outer fluid channels.

In an embodiment, the inlet of an inner fluid channel is adjacent to an outlet of an outer fluid channel. As shown in FIG. 2, the inner fluid channel inlets 250A, B, and C are all disposed proximate to the outer fluid channel outlets 261A, B, C, respectively. Similarly, the inner fluid channel inlets 250A, B, and C are disposed proximate to the inner fluid channel outlets 251A, B, and C, respectively. This interleaving of the inner fluid inlets between the outlets of the inner and outer fluid channels further improves temperature uniformity of the chuck assembly, particularly in a radial direction, proximate to the interface between the inner and outer zones 202, 204 for example, by introducing the coldest heat transfer fluid proximate to the regions where the warmest heat transfer fluid exits. Thus, in this exemplary embodiment, the outer fluid channel inlets 260A, B, and C are all at the extreme peripheral edge of the cooling channel base 144. This positioning has also been found advantageous relative to reversing the flow direction through the outer fluid channels 241A, B and C with improved temperature uniformity at the extreme edge of the chuck assembly being best regulated with induction of fresh supply fluid (e.g., coldest heat transfer fluid).

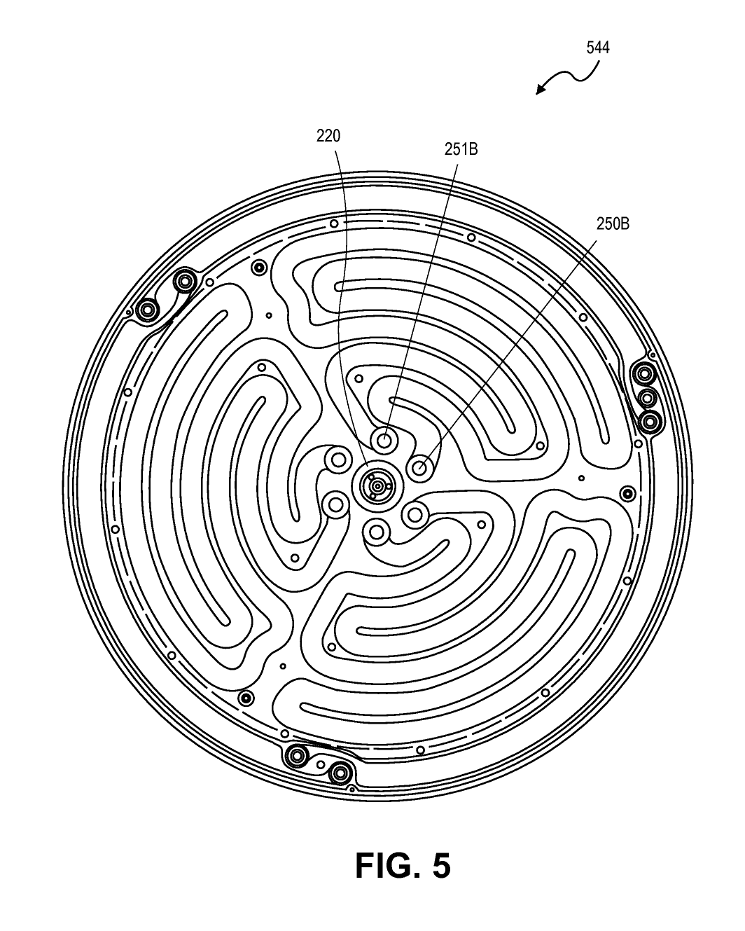

FIG. 5 illustrates a cooling channel base 544 an alternative layout of the inner fluid channels where the inlets (e.g., 250B) and outlets (e.g., 251B) are disposed near the chuck center 220. While this embodiment lacks the advantage of having the inner fluid channel inlet proximate to the outer fluid channel outlet, a compact arrangement about the center 220 provides for easy plumping of fluid supply and return lines coupling to the cooling channel base 544. It should also be noted in the context of both FIGS. 2 and 5 (i.e., cooling channel base 144 or 544) that the flow direction may be changed if desired, with any of the inlet 260A being exchangeable with the outlet 261A, 260B exchangeable with 261B, and 260C exchangeable with 261C. Similarly, for the inner flow channels, the flow direction may be changed if desired, with any of the inlet 250A exchangeable with the outlet 251A, 250B exchangeable with 251B, and 250C exchangeable with 251C.

In an embodiment, a thermal break 270 is disposed in the cooling channel base 144 between the inner and outer fluid channels 240, 241 to reduce cross talk between the inner and outer portions 202, 204. For the exemplary embodiment having an inner portion 202 extending outward from a central axis 220 to a first radial distance and an outer portion 204 forming an outer annulus centered about the central axis 220 which extends outward from a second radial distance to an outer edge of the base 144, the thermal break 270 forms an annulus disposed a third radial distance between the first and second radial distances to encircle the inner portion 202. The thermal break 270 may be either a void formed in the cooling channel base 144, or a second material with a higher thermal resistance value than that of the surrounding bulk.

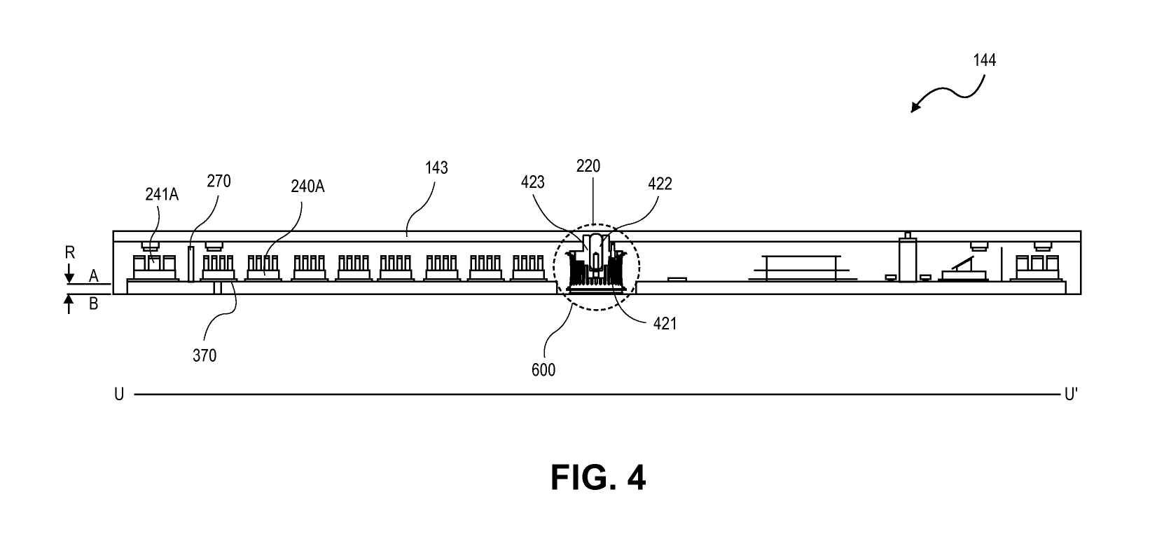

In an exemplary embodiment, the thermal break 270 is discontinuous along an azimuthal distance or angle of the cooling channel base 144. As shown in FIG. 2, the thermal break is made up of segments (e.g., 270A and 270B) with adjacent segments separated by the bulk material of the cooling channel base 144 (e.g., aluminum). For example, approximately 2 mm of bulk material may space apart adjacent thermal breaks. FIG. 4, illustrating a cross-section of the cooling channel base 144 along the line U-U′ illustrated in FIG. 2, shows how the thermal break 370 extends through a partial thickness of the cooling channel base 144. Generally, the radial width of the thermal break 270 may vary, but a void 0.030 to 0.100 inches has been found to provide significant reduction in cross-talk between the portions 202 and 204.

As shown in example of FIG. 4, the thermal break 370 is a void formed in the cooling channel base 144. The void may either be unpressurized, positively or negatively pressurized. In alternative embodiments where the thermal break 370 is of a thermally resistive material, the thermal break 370 may be a material (e.g., ceramic) having greater thermal resistivity than that utilized as the cooling channel base 144 (which may be, for example, aluminum). With the larger dimension of cooling channel base 144 (e.g., 450 mm), mechanical rigidity becomes more of a concern than for smaller diameters (e.g., 300 mm). Because the thermal break 370 can reduce rigidity of the base 144, the thermal break 370 is made discontinuous along the azimuthal direction to provide adequate mechanical rigidity of the cooling channel base 144.

In embodiments, both inner and outer fluid channels include channel segments that are interlaced so that the fluid flows are in the opposite direction in radially adjacent segments. As depicted in FIG. 2, at least a portion of the one or more fluid channels 240 are machined into the cooling channel base 144. In the exemplary embodiment, at least one of the inner fluid channels 240 include a plurality of parallel grooves formed within the channel base 144. The parallel grooves of one inner fluid channel 240 (e.g., 240A) conduct fluid in parallel and share the single inlet and single outlet of the particular fluid channel. These parallel groove channels then fold back on themselves as the inner conduit progresses along in the radial direction. In contrast, the outer fluid channels 241 do not include parallel channels in favor of including at least one point where the outer fluid channel folds back on itself by approximately 180°. For example, as shown in FIG. 2, the outer fluid channel 241A includes a first 180° turn 247A and a second 180° turn 247B so that the outer fluid channel 241 is a “tri-fold” design. This tri-fold design improves thermal uniformity of the outer zone 204 over the azimuthal angle spanned by each of the three runs between the turns 247A and 247B through counter-current flow within the outer zone 204. The smaller cross-section area of the outer fluid channel 241 relative to that of the inner fluid channel 240 also permits one of the outer fluid conduits to run past the inlet of an adjacent outer fluid conduit. Furthermore, because the total length of the outer fluid channel 241 is relatively less than that of the inner fluid channel 240, pressure drop of the inner fluid channels having parallel flow is comparable to pressure drop of the outer fluid channel with both providing an advantageously high Reynolds number.

In an embodiment, each separate fluid conduit formed in the base comprises a channel formed in the base with a separate cap bonded to the channel. Generally, the cap is to be of a material having a coefficient of thermal expansion (CTE) that is well matched to that of the base. In one exemplary embodiment, the caps 370 are of the same material as that of the base (e.g., aluminum). Because the cap is to be welded along the perimeter of the channels, the cap can be advantageously cut from a sheet good of minimal thickness. With a separate bonded cap, the mass of the individual channel caps is minimal and obviates the need to have a sub-base plate of the same surface area as the chuck for sealing surface all the channels as a group. Elimination of the sub-base plate reduces the mass of the chuck assembly by nearly 30% over prior designs. This reduced mass translates into faster transient thermal response compared to prior designs.

FIG. 3 illustrates a plan view of the cooling channel base 144 with the caps 370 separately enclosing the inner and outer fluid conduits 140, 141. As shown the caps 370 are closed polygons having perimeters that follow the path of the inner fluid channel 240 and follow the outer perimeter of the tri-folded path of the outer fluid channel 241, to form separate inner and outer fluid conduits 140, 141, respectively. In regions between the caps 370 is only the bulk of the cooling channel base 144. As further illustrated in FIG. 4, the caps 370 are recessed from the plane B of the bulk cooling channel base 144 to plane A. This amount of recess R ensures artifacts from the bonding of the cap to the cooling channel base 144 do not need to be milled off (e.g., with an end mill) for the purposes of providing clearance of the plane B, which is to couple to an underlying support surface, as such end milling may compromise integrity of a fluid conduit. An exemplary recess R between a top surface of the cap relative to the unrecessed surface of the base 144 is approximately 50 mill (0.050″). Hence, milling of fluid channels into the base 144 may entail forming a lip along the outer perimeter into which the caps 370 are to be seated. In the exemplary embodiment, the cap 370 is e-beam welded to the recessed lip of the channel to make a sealed conduit.

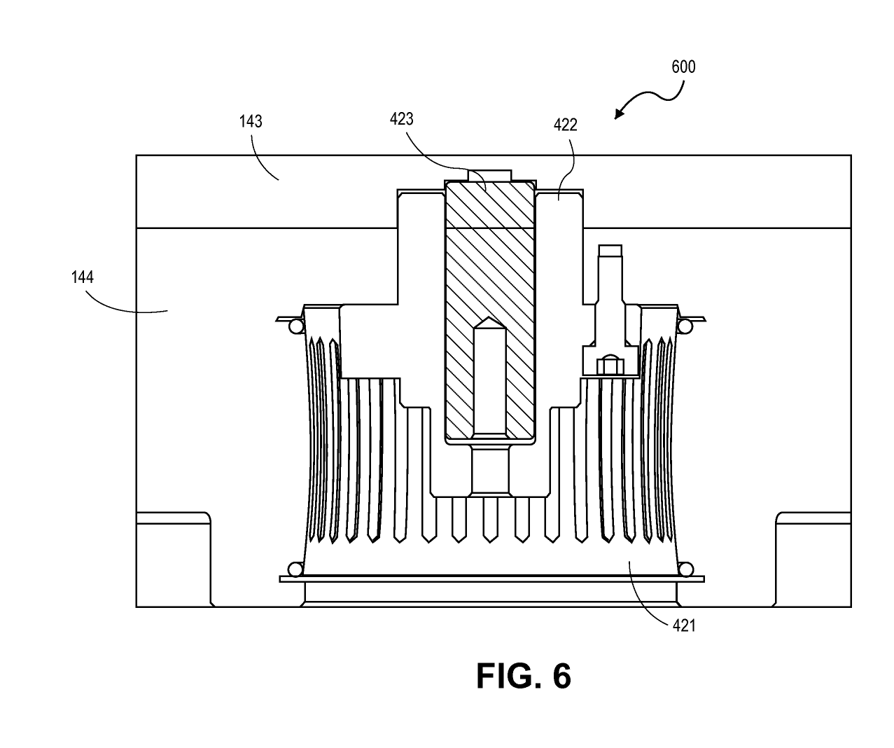

In further embodiments, an RF and DC electrode is to be inserted into the cooling channel base 144. As shown in FIGS. 2-5, these electrodes are to be coupled at the center 220. In the cross-sectional view of FIG. 4, and as further shown in FIG. 6, which is an expanded view of the RF/DC base coupler 600 in FIG. 4, the cooling channel base 144 includes a multi-contact fitting 421 forming an outer circumference of the RF/DC base coupler 600 to couple to an RF connector. A second conductive fitting 423 (e.g., a copper socket), forms an inner circumference of the RF/DC base coupler 600 to couple to a DC connector supplying a DC potential for the electrostatic coupling through the dielectric layer 143. An insulator 422, of a material such as PTFE or other similar dielectric, is disposed between separate electrical fittings in the RF/DC base coupler 600. With the RF/DC base coupler 600 embedded as a portion of the cooling channel base 144, no RF sub-base plate is required in addition to the cooling channel base 144 to couple RF into the plasma process chamber. Thus, the cooling channel base 144 serves the dual purpose of RF coupling and conducting heat transfer fluid through a chuck assembly. The chuck assembly mass is thereby reduced, and therefore the heat transfer response time is improved compared to designs with having an RF coupling electrode distinct from a cooling channel base

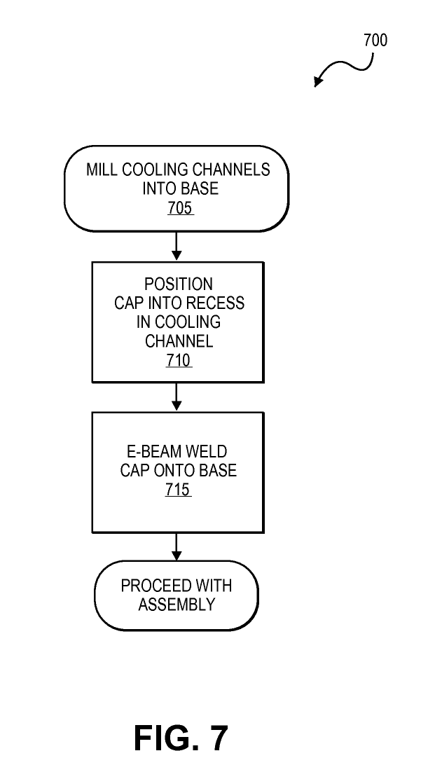

FIG. 7 is a flow diagram illustrating a method 700 for manufacturing a cooling channel base in accordance with an embodiment. The method 700 begins with at operation 700 with milling a fluid conduit pattern into a base material, such as billet aluminum (e.g., 6061). At operation 710, caps, for example of a sheet good having the same material composition as that of the base material (e.g., aluminum) to have a matched coefficient of thermal expansion (CTE), is cut to be the complement of an individual fluid channel shape. A cap is then positioned over a corresponding cooling channel, for example with the cap resting on a recessed lip of the milled fluid conduits so that a top surface of the cap is recessed below the non-recessed surface of the base.

At operation 715 a weld, preferably an e-beam weld is performed to seal the cap along the fluid conduit perimeter. In advantageous embodiments, no end mill is required after the e-beam weld because the cap recess ensures artifacts of the weld are not proud of the non-recessed base surface. With the cooling channel base fabrication complete, assembly may proceed with bonding of a ceramic puck or other dielectric layer adapted for electrostatic clamping of a workpiece.

It is to be understood that the above description is intended to be illustrative, and not restrictive. For example, while flow diagrams in the figures show a particular order of operations performed by certain embodiments of the invention, it should be understood that such order is not required (e.g., alternative embodiments may perform the operations in a different order, combine certain operations, overlap certain operations, etc.). Furthermore, many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. The scope of the invention should, therefore, be determined with reference to the appended claims, along with the full scope of equivalents to which such claims are entitled.

What is claimed is:

1. A base for a chuck assembly upon which a workpiece is to be disposed during a plasma processing operation, the base comprising:
a first fluid channel recessed into a first portion of the base;
a second fluid channel recessed into a second portion of the base; and
a first and second cap separately sealing the first and second fluid channels to form first and second fluid conduits having separate inlets and outlets.

2. The base of claim 1, wherein each cap comprises a closed polygon of sheet material having a perimeter following the path of the corresponding fluid channel.

3. The base of claim 2, wherein a top surface of the caps are recessed from a top surface of the base.

4. The base of claim 1, further comprising a weld joining the caps to the base.

5. The base of claim 1, wherein the first portion of the base is an inner portion extending outward from a center of the base to a first radial distance, wherein the second portion of the base is an outer portion extending outward from a second radial distance to an outer edge of the base, and wherein the first fluid channel spans a first azimuth angle less than 180°.

6. The base of claim 5, wherein the second fluid channel spans a second azimuth angle that is approximately equal to first azimuth angle.

7. The base of claim 6, wherein the second azimuth angle is offset from the first azimuth angle.

8. The base of claim 5, further comprising a thermal break forming an annulus disposed a third radial distance between the first and second radial distances to encircle the inner portion.

9. The base of claim 8, wherein the thermal break is discontinuous along an azimuthal distance or angle of the base with adjacent thermal break segments separated by bulk material of the base.

10. The base of claim 5, wherein the first fluid channel comprises a plurality of parallel grooves running the length of the first fluid channel to conduct fluid in parallel paths that extend between a first inlet and first outlet.

11. The base of claim 5, wherein the second radial distance is approximately equal to a diameter of an inlet to the second fluid channel and wherein the second fluid channel folds back on itself by approximately 180° to have radially adjacent segments within the second portion that conduct fluid flow in opposite directions.

12. The base of claim 11, wherein the second fluid channel folds back on itself by approximately 180° twice to have three radially adjacent segments spanning at least a portion of the second azimuth angle.

13. The base of claim 5, wherein the first fluid channel is one of a plurality of inner fluid channels, each inner channel extending outward from a center of the base to the first radial distance and spanning an azimuth angle of approximately 120°, and wherein the second fluid channel is one of a plurality of outer fluid channels, each outer channel extending outward from the second radial distance to the outer edge of the base and spanning an azimuth angle of approximately 120°.

14. The base of claim 13, wherein an inlet of the first fluid channel is radial adjacent to an both an outlet of the first fluid channel, disposed at a smaller radial distance from the base center than is the inlet of the first fluid channel, and an outlet of the second fluid channel, disposed at a greater radial distance from the base center than is the inlet of the first fluid channel.

15. The base of claim 1, further comprising an electrically conductive multi-contact RF fitting embedded in the base material at a center of the base, the multi-contact RF fitting forming an outer annulus surrounding a conductive inner socket to receive a DC potential input to an electrostatic chuck disposed on the base.

16. A method of forming a chuck assembly upon which a workpiece is to be disposed during a plasma processing operation, the method comprising:
forming a fluid channel into a base material;
cutting a sheet good into a cap having a shape corresponding to that of the fluid channel; and
welding the cap to the fluid channel.

17. The method of claim 16, wherein forming the fluid channel further comprises milling a plurality of parallel grooves within an interior of the channel and milling a recessed lip along an outer edge of the channel, and wherein the method further comprises disposing the cap on the recessed lip and sealing the cap along the outer edge with the welding.

18. The method of claim 17, wherein the welding further comprising e-beam welding.

19. A plasma etch chamber comprising:
a workpiece support assembly comprising electrically conductive base, and an electrostatic chuck further comprising a dielectric, disposed on the base, wherein the base further comprises:
a first fluid channel recessed into a first portion of the base;
a second fluid channel recessed into a second portion of the base; and
a first and second cap separately sealing the first and second fluid channels to form first and second fluid conduits having separate inlets and outlets;
an RF generator coupled to the base;
a process gas supply; and
a pump stack to evacuate the chamber.

20. The etch chamber of claim 19, wherein the RF generator is coupled to an electrically conductive multi-contact RF fitting embedded in the base material at a center of the base.
